(19) United States
(12) Patent Application Publication
(10) Pub. No.: US 2020/0302526 A1
(43) Pub. Date: Sep. 24, 2020

(54) MAKE LIVE AT ORDER PROCESSING SYSTEM AND METHOD

(71) Applicant: TRADITION AMERICA, LLC, New Yorfk, NY (US)

(72) Inventor: Kristofer SPINKA, New York, NY (US)

(21) Appl. No.: 16/088,036

(22) PCT Filed: Mar. 24, 2017
(86) PCT No.: PCT/US2017/024041

§ 371 Date: Sep. 24, 2018

(51) Int. Cl. G06Q 40/04; G06Q 10/04; G06F 17/18; G06F 16/2455

(52) U.S. Cl. CPC G06Q 40/04; G06Q 10/04; H04L 69/28; G06F 16/2455; G06F 17/18

(57) ABSTRACT

A system, including: processing circuitry executing upon at least one computing device; and a non-transitory computer readable medium, coupled to the processing circuitry, storing machine-executable instructions including instructions operable when executed on the processing circuitry to cause the processing circuitry to: receive, from a first customer computing system of a plurality of customer computing systems, an order comprising a product identifier, at least one order characteristic, and pricing information; access historical data for executed orders fulfilled by a plurality of market venues over a prior period of time; determine a set of real-time order statistics for a plurality of executed orders fulfilled by at least a portion of the plurality of market venues over a recent period of time; apply the historical data and the realtime order statistics to determine an expected behavior of each market venue of the plurality of market venues.

### CROSS REFERENCE TO RELATED APPLICATION

This application claims priority to U.S. Provisional Patent Application No. 62/312,884, filed Mar. 24, 2016, the contents of which are incorporated herein by reference.

### BACKGROUND

Broker systems route held orders, including orders from retail investors, to a variety of venues for execution. Venues include market makers, alternative trading systems, and registered exchanges. Retail orders are defined as orders from individual investors, and held orders are orders where the executing broker/market maker is obligated to fill, display, or route the order to another venue. Typically, these orders are benchmarked against the current National Best Bid and Offer (NBBO) on arrival.

Brokers have an obligation to their customers to obtain the best price for orders received from their customers and to regularly review how the orders were executed. Existing retail order routing systems generally employ rigid routing schemes that process all orders for a given equity to a single broker or group of brokers and are typically manually updated. Performance of these routing schemes is typically reviewed once per quarter using metrics as described in Security & Exchange Commission (SEC) Rule 605.

Existing systems are not optimal in that system latency, among other factors, may impact the time at which an order arrives at a market venue. Since market venues typically fill orders on a first in, first out (FIFO) methodology, keen participants in the market may detect a trading pattern before the held order can be completed. This represents a significant disadvantage because a keen participant, such as a high frequency trader, may manipulate the price of the security being traded before the order can be filled.

The foregoing general description of the illustrative embodiments and the following detailed description thereof are merely example aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a block diagram of an example network topology of an order routing system, according to certain embodiments;

FIG. 2 is a block diagram of an example processing module configuration of the order routing system of FIG. 1;

FIG. 3 is a block diagram of an example network topology of a market venue;

FIG. 3A is a block diagram of an example network topology of a market venue;

FIG. 4 is a block diagram of an example network topology of a trading floor;

FIG. 5A is a flow chart of an example order placement method according to certain embodiments of the invention;

FIG. 5B is a flow chart of an example order placement method according to certain embodiments of the invention;

FIG. 5C is a flow chart of an example order placement method according to certain embodiments of the invention;

FIG. 6 is a flow chart of an example order placement method according to certain embodiments of the invention;

FIG. 7 is a block diagram of an example computing device.

In the drawings, like reference numerals designate identical or corresponding parts throughout the several views.

### DETAILED DESCRIPTION

Systems and methods for adapting held order flow to enhance order execution performance are configured to determine a make live time for an order as orders are processed by market venues (e.g., market makers, ATSs, or registered exchanges). The make live time may be determined using a number of factors, including real-time execution information, historic performance data, customer preferences, clock time at a venue, and the ability of a venue to fill the order, among other factors.

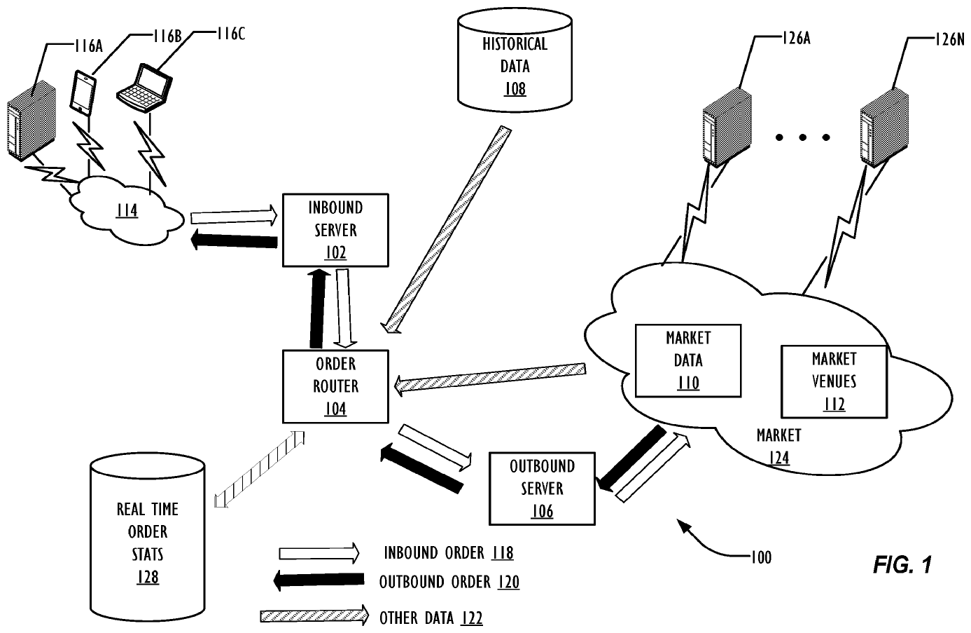

FIG. 1 is a block diagram of an example order routing system 100, including one or more processing systems (e.g., processors, computing devices, servers, virtual machines, parallel processing threads, etc.), such as an inbound server 102, order router 104, and outbound server 106, which are configured to receive inbound orders 118 submitted by customers 11, identify the appropriate market venue(s) 126 for fulfillment of each of the orders based on factors such as displayed liquidity, commissions and/or rebate structures, latency, market spread, projections on execution volume for an instrument based on the venue, best inside market on either bid or ask, and fill ratios, route the inbound orders 118 to the selected market venues 126, and update market venue statistics in real-time based on actual fill data 122 to refine the expected behaviors of the market venues 126. The order routing systems communicates with customer devices 116, such as end retail investors and/or retail brokers, via a customer network 114. As such, a particular order may be submitted directly to the order routing system 100 via a customer computing device 116a or 116b, or the order may reach the order routing system 100 via one or more intermediary computing systems 116c, such as a retail brokerage computing system. The customer network 114, depending upon the deployment configuration of the order routing system 100, may include the Internet, one or more intranets, local area networks (LANs), Wide Area Networks (WANs), and/or Metropolitan Area Networks (MANs). Further, although the customer devices 116 are illustrated as communicating with the customer network 114 through wireless connections, depending upon the deployment configuration, some customer devices 116 may communicate with the customer network 114 via a wired or cabled connection. Upon determining an appropriate route for the particular order, the order routing system 100 routes the particular order to a selected market venue 126 via a market network 124 which may include similar network components as described in relation to the customer network 114. Additionally, in some embodiments, at least a portion of the networking configuration of the customer network 114 may be shared with the market network 124.

In some embodiments, the inbound server 102 receives customer inbound orders 118 placed by customers via the customer network 114. The customers may place the inbound orders 118 directly to the inbound server 102 via customer computing devices such as customer devices 116a, 116b, and/or the inbound orders 118 may be submitted by one or more intermediate computing systems 116c on behalf of the customers. In some examples, a particular customer may place an order with the inbound server 102 through the intermediate computing system 116c via a web interface, handheld device application, or telephone interface. The inbound server 102 may normalize the inbound orders 118 prior to providing the inbound orders 118 to the order router 104. For example, the inbound server 102 may convert customer-specific order formats into a common format that corresponds to a format used by the order router 104 for making trading/routing decisions. The order router 104 in turn, may make trading/routing decisions, such as selecting market venues 112 for routing the inbound orders 118.

The outbound server 106, in some embodiments, receives the inbound order 118 from the order router 104 and formats the inbound orders 118 for the market venues 112. Once the orders are filled by the market venues 112, the outbound server 106 may normalize actual fill data 120 (interchangeably referred to as a filled order) received from the market venues 112 and pass the actual fill data 120 to the order router 104 where real-time order statistics 128 are updated. For example, individual market venues may process orders based on a venue-specific format, so the outbound server converts the order data from the order router 104 to the venue specific format when placing the order. The real time order statistics 128 may also be based in part on market data 110 reflecting order activity external to the order routing system 100 (e.g., orders placed via other order placement systems in communication with the market venues 112).

As discussed further herein, the order router 104, in some embodiments, makes order routing decisions based on the real-time order statistics 128 as well as historical data 108. In one example, a database server (not illustrated) includes processing logic configured to process the historical data 108. In another example, a database server stores the historical data 108, which is processed by the order router 104. The order router 104 may also route the actual order data 120 to the inbound server 102, which may format the fill data 120 in accordance with customer (or third party intermediary) specifications.

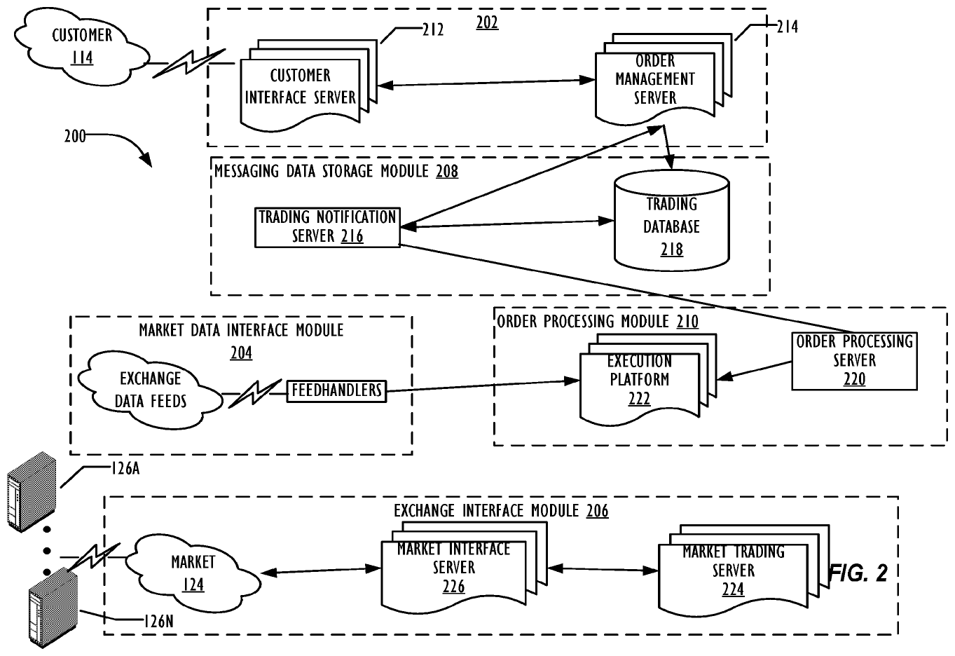

FIG. 2 is a block diagram of an example processing module configuration 200 of the order routing system 100 of FIG. 1, according to certain embodiments. The processing module configuration 200 provides a detailed processing flow for the routing of orders through the order routing system 100. The processing module configuration 200 includes a number of discrete processing modules, such as an order management module 202, a message data storage module 208, a market data interface module 203, an order processing module 210, and an exchange interface module 206 for handling order receipt and fulfillment. Each module may include one or more routers/servers or other processing logic or circuitry that executes the processes described herein. The distribution of processing circuitry shown in the processing module configuration 200 is merely example and other computing systems, processing circuitry, and/or distribution of processing tasks may be used.

In some embodiments, the inbound server 102 of the order routing system 100 of FIG. 1 includes the order management module 202. The order management module 202 may include a customer interface server 212 that receives a customer order via the network 114. The customer interface server 212 may send an order acknowledgement to the customer and route the order to an order management server 214. The order management server 214 may validate the order to ensure the order is in accordance with customer specifications and then transmit the order to the messaging data storage module 208.

The inbound server 102, in some embodiments, includes the messaging data storage module 208, having a trading database 218 as well as a trading notification server 216. The order transmitted from the order management module 202 to the messaging data storage module 208 may be posted to the trading database 218 and notify an order processing server 220 in the order processing module 210. In some embodiments, the outbound server 106 of FIG. 1 includes the order processing module 201. The order processing server 220 may query the trading database 218 in response to the notification to obtain the order information from the trading database 218.

In addition to the order processing server 220, in some embodiments, the order processing module 201 also includes an execution platform 222. The order processing server may provide the order to the execution platform 222 and the execution platform 222 may determine routing information for the order based on factors such as displayed liquidity, commissions and/or rebate structures, latency, market spread, projections on execution volume for an instrument based on the venue, best inside market on either bid or ask, and fill ratios, customer trading specifications, the historical data, and real-time order statistics. In one example, the real-time order statistics are based on live market data received from the market data interface module 204 (e.g., included as part of the order router 104 of FIG. 1). The execution platform 222 may send the order routing information to a market trading server 224 in the exchange interface module 206.

In some embodiments, the outbound server 106 of FIG. 1 may include the exchange interface module 206. Within the exchange interface module 206, the market trading server 224 routes the order according to the order routing information to an instance of a market interface server 226 associated with a particular destination market venue 126. The market interface server 226 may route the order to the selected destination market venue 126 via the market network 124, where the order is filled.

When the order is filled, in some embodiments, the market interface server 226 receives the actual fill data (also referred to as fill details), via the market network 124 from the market venue 126 and routes the actual fill data (e.g., filled order 120) back to the market trading server 224. The market trading server 224 may post the fill details to the trading database 218 of the messaging data storage module 208 and also provide the fill details to the execution platform 222 of the order processing module 210 in a normalized format. The execution platform 222 may update the real-time order statistics based on the actual fill data so that future orders are based on the requested fill data from a current order.

At the messaging data storage module 208, the trading notification server 216, in some embodiments, identifies the fill details posted to the trading database 218 and sends the fill details to the order management server 214 of the order management module 202. The order management server 214 may provide the fill details to the customer interface server 212, and the customer interface server 212 may route the fill details to the customer via the network 114 in a predetermined format. Customers who initiate orders via the order routing system 100 can specify one or more target metrics that are used by the order router 104 to make determinations regarding where orders are routed. Target metrics, in some examples, can include execution speed, price improvement, fill rate, and the like. The order router 104 of FIG. 1, for example, can select the market venues 126 for routing received orders based at least in part on expected performance of the market venues 126 with respect to the customer's target metrics.

In some embodiments, market data may be received in real-time, which is less processed and includes less analytics. Examples of real-time, lower latency market data include Reuters® Data Feed Direct and Bloomberg B-Pipe®. (REUTERS is a registered trademark of Thomson Reuters Canada Limited; B-PIPE is a registered trademark of Bloomberg Finance One L.P.) In some embodiments, latency may also be reduced by receiving feeds directly from an exchange.

In some embodiments, the system may also account for latency in trading data. This bi-directional traffic can often be latency sensitive. It some embodiments, the data is communicated in FIX® format (Financial Information eXchange) using FIX engines. (FIX is a registered trademark of Fix Protocol Limited.) Some embodiments may also use order management systems. FAST (Fix Adapted for Streaming) may also be used in some embodiments. FAST uses compression to reduce message length, which reduces latency. Additionally, in some embodiments, the system may be configured for direct market access (DMA). DMA enables direct routing a securities order to a market venue 126. Other trading messaging formats and configurations are also within the scope of the present invention.

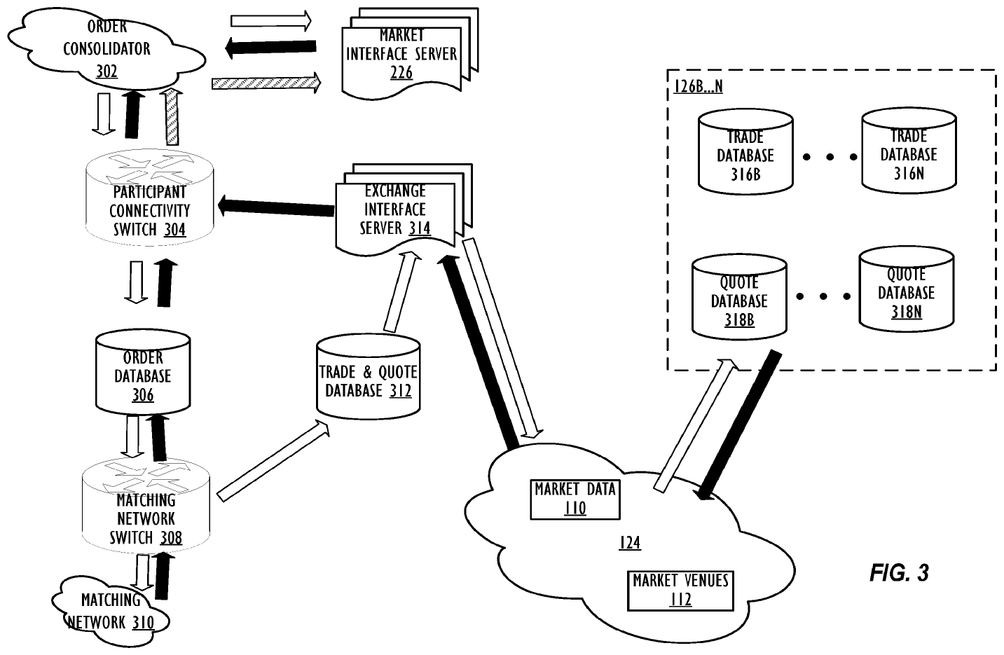

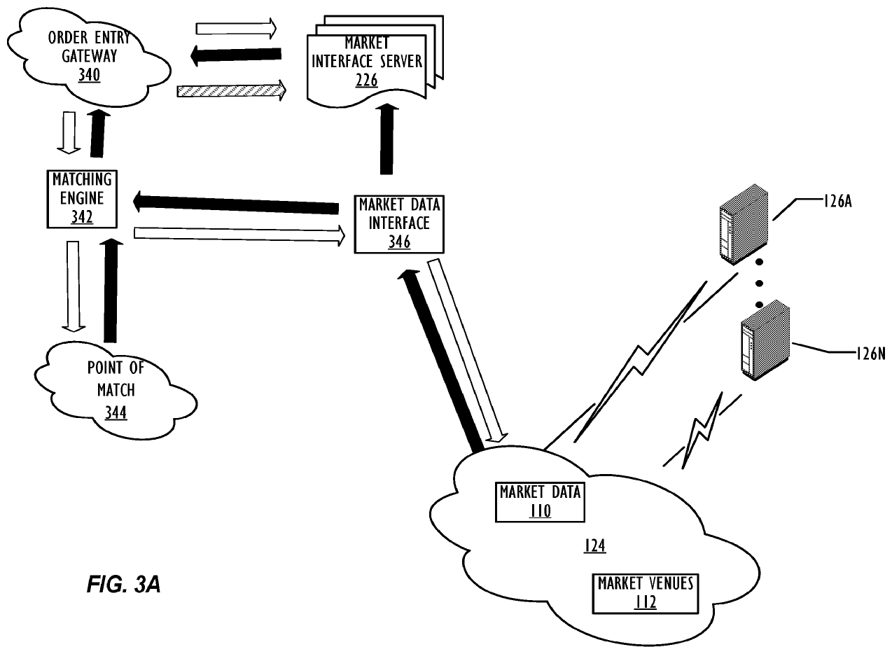

FIG. 3 further illustrates a non-limiting example of the configuration of a market venue according to some embodiments of the invention. As shown in FIG. 3, the market interface server 226 may send an inbound order 118 to order consolidator 302. In market venues which do not feature an order consolidator 302, the market interface server 226 may communicate directly with participant connectivity switch 304. From there, the inbound order 118 may be sent to order database 306, which in turn may send inbound order 118 to the matching network 310 for execution.

In FIG. 3, a matching engine may reside in any of participant connectivity switch 304, order database 306, or matching network switch 308, depending on desired performance characteristics. If the matching engine determines that the inbound order 118 cannot be filled by matching network 310, any of participant connectivity switch 304, order database 306, or matching network switch 308 may transmit the unfilled order to trade and quote database 312 for publication to the market venue 126. For illustration purposes, the matching engine in FIG. 3 is positioned at the matching network switch 308, which is why the matching network switch 308 is illustrated as communicating the unfilled inbound order 118 to the trade and quote database 312.

Once the order has been filled, filled order 120 is sent from the matching network 310 to the matching network switch 308. Matching network switch 308 may send the filled order 120 to the order database 306. After the filled order reaches the order database 306, it may be sent to participant connectivity switch 304 and then to order consolidator 302. If the market venue is not using an order consolidator 302, the participant connectivity switch 304 may send the filled order 120 to the market interface server 226.

In the case of the information about inbound order 118 sent to the trade and quote database 312, it may then be sent to an exchange interface server 314. In some embodiments, the exchange interface server 314 may communicate information about inbound order 118 to market venue 126. More specifically, the exchange interface server may send inbound order 118 to specific market venues 126b . . . 126n for their trade databases 316b . . . 316n and quote databases 318b . . . 318n for execution on an alternative venue.

According to some embodiments of the invention, when an inbound order 118 includes make live information, the matching engine may position the inbound order 118 in the trading queue such that it will appear live at the time specified in the make live information. In some embodiments, participant connectivity switch 304 may achieve the desired positioning by placing a temporary hold on the order prior to passing it to order database 306. In some embodiments, participant connectivity switch 304 may transmit the inbound order 118 to the order database 306 in FIFO, with instructions for the order database 306 to delay transmission to the matching network switch 308 until a specified time. In some embodiments, order database 306 may pass the inbound order 118 to matching network switch 308 in FIFO with an instruction to delay transmission to the matching network until the time specified in the make live information. In this example, the matching engine is positioned at the participant connectivity switch 304.

In some embodiments, when the matching engine may be located at the order database 306, transmission of the inbound order 118 is processed accordingly. So, for example, if the matching engine is located at the order database 306, the order database 306 may place a hold on the inbound order 118 to delay its transmission or may transmit it to matching network switch 308 with an instruction to delay transmission to the matching network until the time specified in the make live information.

Likewise, in some embodiments, the matching engine may be positioned at matching network switch 308. In that case, the matching network switch 308 may delay transmission of the inbound order 118 to the matching network until the time specified in the make live information.

In some embodiments of FIG. 3A, the filled order information may be transmitted to a location other than market interface server 226. For example, the filled order information may be transmitted to other market venues.

In some embodiments, the matching engine may be comprised of a server peripheral card, a server module, an FPGA, ASIC, software, a combination of the aforementioned, or other desired elements. In some embodiments, the matching engine may include a processor working in embedded logic on an embedded database.

FIG. 3A illustrates a market network configuration according to some embodiments of the invention. In the example of FIG. 3A, market interface server 226 may send inbound order 118 to an order entry gateway 340 of a market venue. Optionally, the order entry gateway 340 may acknowledge receipt of the order to the market interface server 226. From the order entry gateway 340, the inbound order 118 may be transmitted to matching engine 342. If the matching engine 342 determines that the order is capable of being filled at that market venue, the inbound order 118 may be transmitted to the point of match 344. If the matching engine 342 determines that the inbound order 118 cannot be filled in the venue, the matching engine may transmit the inbound order 118 to market data interface 346. From there, the inbound order 118 may be transmitted to the market venue 126 for execution. Once the order is filled, the filled order 120 may be transmitted from the market venue 126 to the market data interface 346. In turn, the market data interface 346 may transmit the filled order to the matching engine 342, and the matching engine 342 may transmit the filled order to the order entry gateway 340 for transmission to the market interface server 226.

In some embodiments of FIG. 3A, the filled order information may be transmitted to a location other than market interface server 226. For example, the filled order information may be transmitted to other market venues. Additionally, in some embodiments of FIG. 3A, the market data interface 346 may communicate filled order 120 to market interface server 226, directly or via intermediaries.

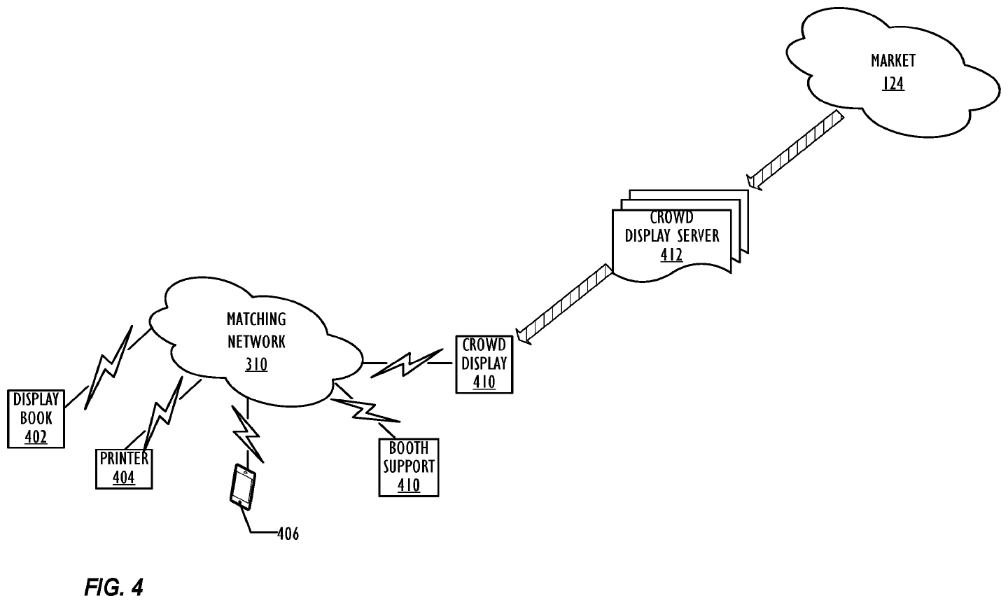

FIG. 4 provides a more detailed explanation of the matching network 310 according to some embodiments of the invention. Display book 402, printer 404, handheld device 406, booth support 408, and crowd display 410 may all send and receive information interactively. The matching network may provide the point of match for the trade, for example via the display book 4. Crowd display 410 may receive information from crowd display server 412, which in turn may receive information from market venue 126. The crowd display server 412 may provide additional information regarding trading activity in other selected market venues 126a . . . 126n.

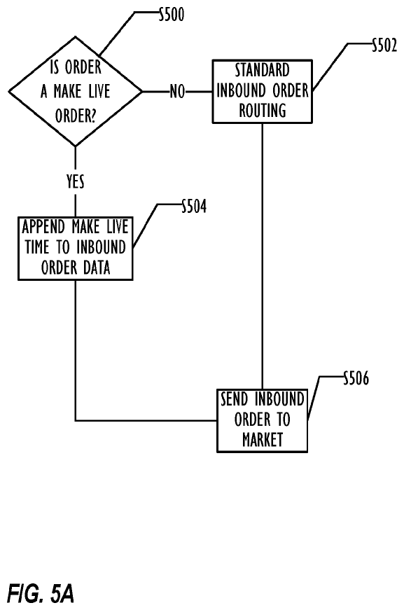

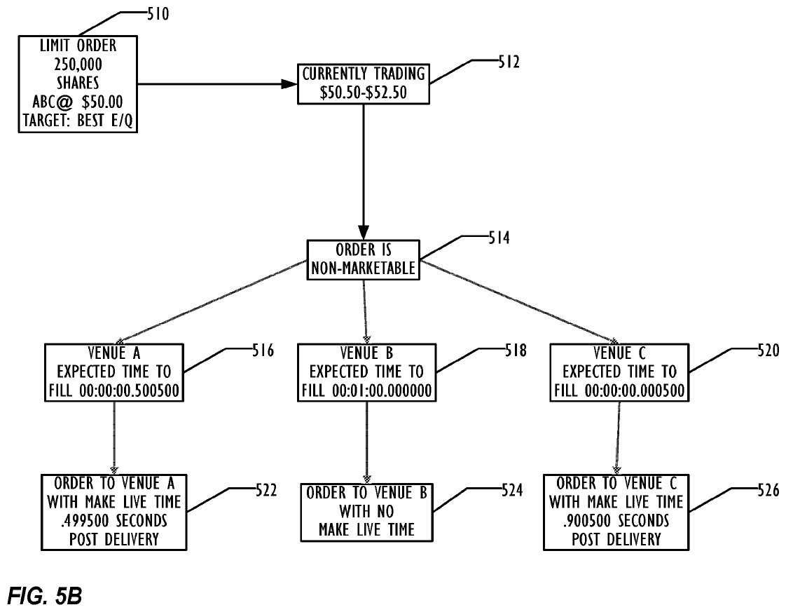

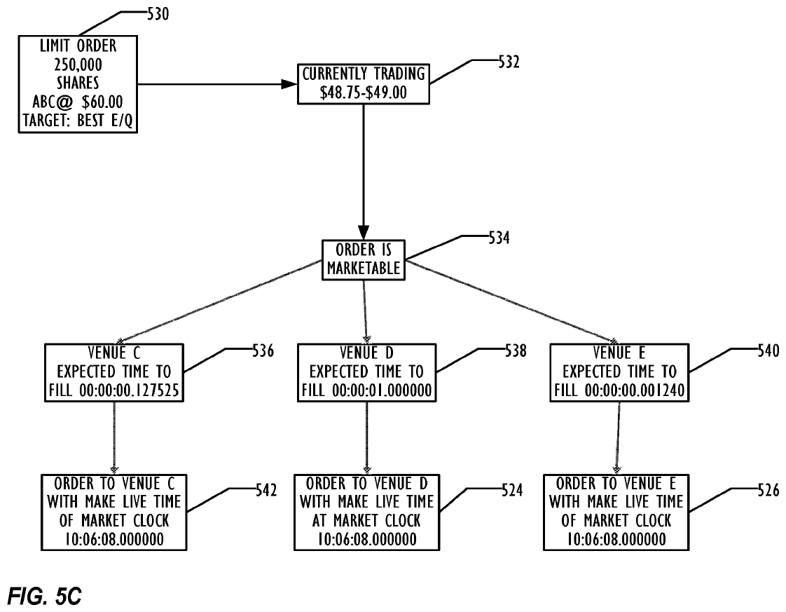

FIG. 5A presents a flow chart for an inbound order according to some embodiments of the invention. As shown in FIG. 5, the system determines if the inbound order 118 is a make live order. If the answer is no, then the system may proceed to standard inbound order routing in step S502. After step S502, the system may proceed to send the inbound order 118 to the market venue 126. If the answer is yes, the system may append make live time to inbound order data in step S504. After step S504, the system may send the inbound order 118 to the market venue 126. In this way, the system is able to handle both make live inbound orders and standard inbound orders.

FIG. 5B illustrates example make live order routing according to some embodiments of the invention. In 510, a limit order is desired for 250,000 shares of ABC at $50.00/share, with a target of Best E/Q. Market data 110 shows that the stock is currently trading in the range of $50.50-$52.50 in 512 at venues A-C, so the order is classified as non-marketable (meaning the conditions of the order are not met for an immediate fill) in 514. In some embodiments, one or both of real time order stats database 128 and historical data 108 may be used to determine an expected time to fill for each of venues A, B, and C in 516, 518, and 520. Depending on the calculated time to fill, some embodiments of the invention may append a make live time to the orders placed at each respective venue to normalize the time at which the order becomes visible to the matching network 310. In some embodiments, the order may be divided amongst venues A, B, and C based on a number of factors, including displayed liquidity, commissions and/or rebate structures, latency, market spread, projections on execution volume for an instrument based on the venue, best inside market on either bid or ask, and fill ratios.

An example routing process according to some embodiments of the invention is also illustrated in FIG. 5C. In the example of FIG. 5C, a limit order for 250,000 shares of ABC at $50.00/share with target Best E/Q is specified in 530. The shares are currently trading at $48.75-$49.00 as determined in 532, so the order is deemed marketable (meaning possible to fill at time of order) in 534. Using historical data 108 and/or real time order statistics database 128, venue C has an expected time to fill of 0.127525 seconds in 536, venue D has an expected time to fill of 1.000000 second in 538, and venue E has an expected time to fill of 0.001240 seconds in 540. The system may send all or a portion of the order to venue C in 542 with a make live time of venue C market clock of 10:06:08.000000, all or a portion of the order to venue D in 544 with a make live time of venue D market clock of 10:06:08.000000, and all or a portion of the order to venue E in 546 with a make live time of venue E market clock of 10:06:08.000000. In this example, the market clocks of venues C, D, and E may be synched with each other or they may be asynchronous. Some embodiments of the present invention may query the venue clock time and adjust the make live time accordingly when configuring the order information.

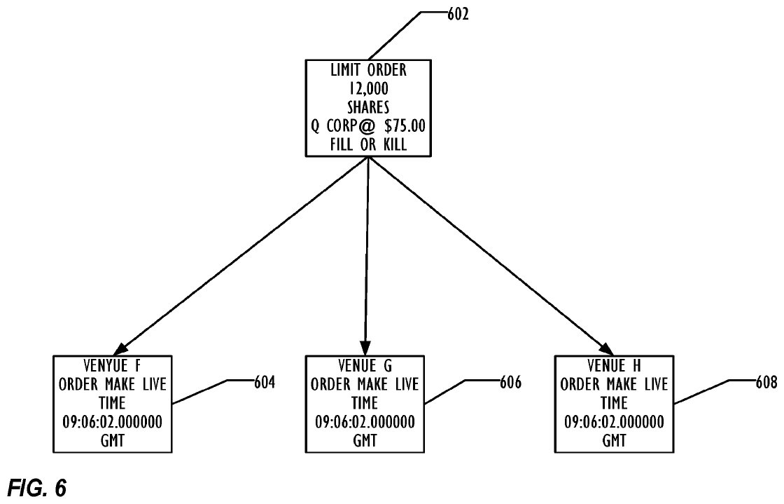

FIG. 6 shows an additional example of some embodiments of the present invention. In 602, a customer requests a limit order of 12,000 shares of Q Corporation at $75.00/share with a “fill or kill” (FOK) condition. In some embodiments of the invention, the system may send the order to venues without determining the current trading prices of Q Corporation shares on any venues. In some embodiments, the system may also send the order to venues without determining the anticipated time to fill or any discrepancies that may exist in respective market clocks between various venues. In the illustrated example, the system sends all or a portion of the FOK order to venue F in 604, venue G in 606, and venue H in 608. While the example of FIG. 6 shows identical make live times, some embodiments of the invention may provide different make live times for all or part of the orders at each venue. In some embodiments, the make live time may vary for any number of reasons, including customer preference, reliability of the venue, desired sequence of execution of trades across venues, pricing factors, broker/dealer preferences, volume of the trade at each venue, latency, anticipated time to fill, or other market factors.

In some embodiments of the invention, the system may account for algorithmic trading preferences. For example, the system may forecast a time at which an inbound order is most likely to be filled. That forecast may use historical data and real-time data, as an example. Based on the forecast, the system may set a make live time to maximize likelihood of trade execution.

In some embodiments, the system may query market clocks of desired venues. The system may calculate a difference in the market clocks of the various venues. If one or more of the market clocks times are identical, the system can account for that in setting the make live time.

According to some implementations, the processing circuitry of order router 104 may also route orders directly to exchanges at times based on order classifications, such as whether the order is marketable or non-marketable, time of day, and the like. In some embodiments, the order router 104 may route orders to the market venues early in the day and then route orders directly to actual exchanges later in the day.

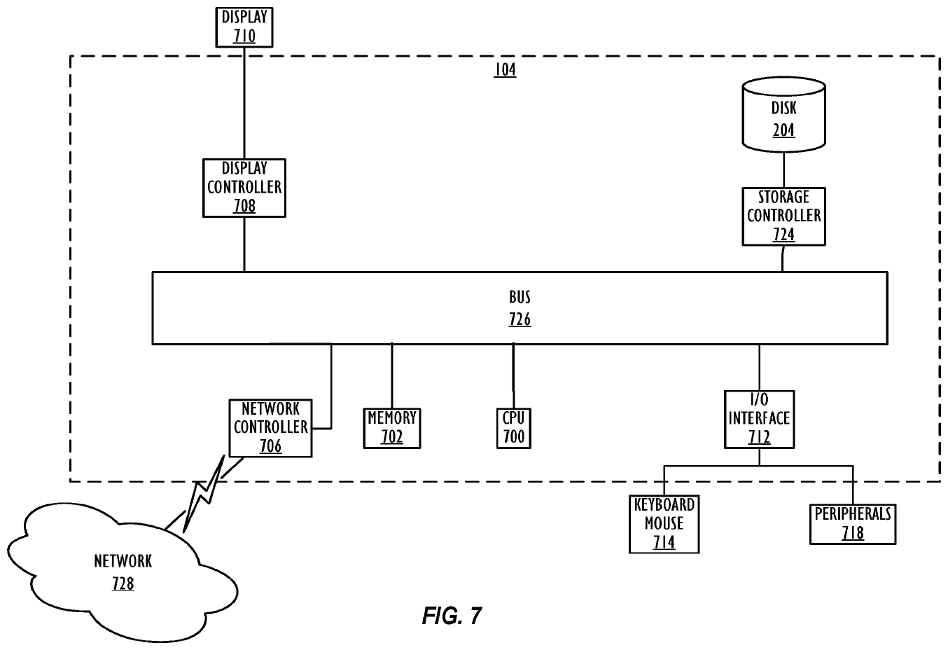

Each of the functions of the described embodiments may be implemented by one or more processing circuits, as illustrated in the example of FIG. 7. A processing circuit includes a programmed processor (e.g., CPU 700). A processing circuit/circuitry may also include devices such as an application specific integrated circuit (ASIC) and conventional circuit components arranged to perform the recited functions. The processing circuitry may be referred to interchangeably as circuitry throughout the disclosure. In addition, when the processors in each of the servers are programmed to perform the processes described herein, they become special-purpose order routing devices. The process performed by order router 104 as well as the other servers of the order routing system 100 are computationally rigorous due to the large amount of data that is processed in association with trading. For example, updating the real-time order statistics and historical data can involve processing gigabytes of data in real-time. Additionally, the servers of the order routing system 100 may use parallel processing to increase speed and efficiency.

The hardware described in connection with FIG. 7 may apply to any of the hardware components of the order routing system 100, such as the inbound server 102, order router 104, and outbound server 106. Similarly, the hardware described in connection with FIG. 7 may also apply to the customer interface server 212, the order management server 214, the trading notification server, 216, the execution platform 222, the order processing server 220, the market interface server 226, and the market trading server 224. Likewise, the hardware illustrated in FIG. 7 may apply to the exchange interface server 314.

Implementation of the processes of the order routing system 100 on the hardware described herein improves the efficiency of routing orders to optimal market venues and determining the execution quality of the filled orders in real-time. Implementation of the processes of the order routing system 100 on the hardware described herein also improves the ability of the system to calculate the desired make live time of a given order or partial order.

The example computing device includes a CPU 700 that may be configured to perform the processes described herein. The process data and instructions may be stored in memory 702. These processes and instructions may also be stored on a storage medium disk 704, such as a hard drive (HDD), solid state drive (SSD), or portable storage medium or may be stored remotely.

CPU 700 may be a Xeon® or Intel Core® processor from Intel Corporation or an Opteron processor from Advanced Micro Devices, Inc., or may be other processor types that would be recognized by one of ordinary skill in the art. (XEON and INTEL CORE are registered trademarks of Intel Corporation.) Alternatively, the CPU 700 may be implemented on an FPGA, ASIC, PLD, or using discrete logic circuits, as one of ordinary skill in the art would recognize. Further CPU 700 may be implemented as multiple processors cooperatively working in parallel to perform the instructions of the inventive processes described herein.

The computing device of FIG. 7 also includes a network controller 706, such as an Intel® PRO Ethernet network interface card from Intel Corporation, for interfacing with a network 728, such as the customer network 114 or the market network 124 of FIG. 1. (INTEL is a registered trademark of Intel Corporation.) As can be appreciated, the network 728 can be a public network, such as the Internet, or a private network such as a LAN or WAN network, or any computation thereof. It may also include PSTN or ISDN sub-networks. The network 728 may also be wired, such as an Ethernet, Infiniband, or switched PCI network, or be wireless such as a cellular network, including EDGE, 3G, and 4G wireless cellular systems. The wireless network can also be Wi-Fi®, Bluetooth®, or any other known wireless form of communication. (WI-FI is a registered trademark of Wi-Fi Alliance; BLUETOOTH is a registered trademark of Bluetooth SIG.)

The computing device further includes a display controller 708 for interfacing with a display 710 of the order router 104, such as an LCD monitor. A general purpose I/O interface 712 at the order router 104 interfaces with a keyboard and/or mouse 714. General purpose I/O interface 712 also connects to a variety of peripherals 718 including printers and scanners.

The general purpose storage controller 724 connects the storage medium disk 704 with communication interconnect 726, which may be an ISA, EISA, VESA, PCI, PCI express, point to point links, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity, since these features are known.

Although the computing device of FIG. 7 is described as having a storage medium disk 704, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates.

Further, the claimed advancements may be provided as a utility application, background daemon, component of an operating system, or combination thereof, executing in conjunction with CPU 700 and an operating system such as Microsoft® Windows®, UNIX, Solaris®, LINUX®, Apple MAC OS®, and other systems known to those skilled in the art. (MICROSOFT and WINDOWS are registered trademarks of Microsoft Corporation; SOLARIS is a registered trademark of Oracle America, Inc., LINUX is a registered trademark of Linus Torvalds; and MAC OS is a registered trademark of Apple Corp.)

In other embodiments, processing features according to the present invention may be implemented and commercialized as hardware, a software solution, or a combination thereof. Moreover, instructions corresponding to the order routing process 400 and/or historical data generation process 500 in accordance with the present disclosure could be stored in a portable drive such as a USB Flash drive that hosts a secure process.

A number of implementations have been described herein. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, of if the components were replaced or supplemented by other components. The functions, processes, and algorithms described herein may be performed in hardware or software executed by hardware, including computer processors and/or programmable circuits configured to execute program code and/or computer instructions to execute the functions, processes, and algorithms described herein. Additionally, an implementation may be performed on modules or hardware not identical to those described. Accordingly, other implementations are within the scope that may be claimed.

What is claimed is:

1. A system, comprising:
processing circuitry executing upon at least one computing device; and
a non-transitory computer readable medium, coupled to the processing circuitry, storing machine-executable instructions including instructions operable when executed on the processing circuitry to cause the processing circuitry to:
receive, from a first customer computing system of a plurality of customer computing systems, an order comprising a product identifier, at least one order characteristic, and pricing information;
access historical data for executed orders fulfilled by a plurality of market venues over a prior period of time;
determine a set of real-time order statistics for a plurality of executed orders fulfilled by at least a portion of the plurality of market venues over a recent period of time;
apply the historical data and the real-time order statistics to determine an expected behavior of each market venue of the plurality of market venues;
append a desired make live time to the order based on the expected behavior of each market venue; and
transmit the order to at least one of the plurality of market venues.

2. The system according to claim 1, wherein the desired make live time is calculated so that the order appears for execution on at least two of the plurality of market venues at approximately a same time.

3. The system according to claim 2, wherein the desired make live time comprises a first make live time for a first market venue and a second make live time for a second market venue.

4. The system according to claim 3, wherein the first make live time is different from the second make live time.

5. The system according to claim 1, wherein the instructions further include instructions to cause the processing circuitry to receive, via a network, first clock information for at least one market venue of the plurality of market venues, and the desired make live time is calculated based at least in part on the first clock information.

6. The system according to claim 5, wherein the instructions further include instructions to cause the processing circuitry to receive, via a network, second clock information for at least a second market venue of the plurality of market venues, and the desired make live time is calculated based on a later of the first clock information or the second clock information.

7. A system, comprising:
processing circuitry executing upon at least one computing device; and
a non-transitory computer readable medium, coupled to the processing circuitry, storing machine-executable instructions including instructions operable when executed on the processing circuitry to cause the processing circuitry to:
receive at a first market venue at a receipt time, from a first order system of a plurality of order systems, an order comprising a product identifier, at least one order characteristic, a make live time, and pricing information;
determine a difference between the receipt time and the make live time; and
queue the order in a queue of a plurality of orders based on the determination.

8. The system according to claim 7, wherein the instructions further include instructions to cause the processing circuitry to:
query a first market clock at the first market venue to obtain a first market time;
query a second market clock at a second market venue to obtain a second market time; and
calculate a time at which to queue the order at the first market venue and a second time to queue the order at the second market venue so that the order appears for execution approximately simultaneously at the first market venue and the second market venue.

9. The system according to claim 8, wherein the instructions further include instructions to cause the processing circuitry to synchronize the first market clock with the second market clock.

10. A system, comprising:
processing circuitry executing upon at least one computing device; and
a non-transitory computer readable medium, coupled to the processing circuitry, storing machine-executable instructions including instructions operable when executed on the processing circuitry to cause the processing circuitry to:
receive, from a first computing system of a plurality of computing systems, an order comprising a product identifier, at least one order characteristic, and pricing information;
append a desired make live time to the order; and
transmit the order to at least a first market venue and a second market venue,
wherein the desired make live time is calculated so that the order appears for execution at the first market venue and at the second market venue approximately simultaneously.

11. The system according to claim 10, wherein the instructions further include instructions to cause the processing circuitry to receive, first clock information for the first market venue, and the desired make live time is calculated based at least in part on the first clock information.

12. The system according to claim 11, wherein the instructions further include instructions to cause the processing circuitry to receive, via a network, second clock information for at least the second market venue, and the desired make live time is calculated based on a later of the first clock information and the second clock information.

13. The system according to claim 11, wherein the instructions further include instructions to cause the processing circuitry to:
access historical data for executed orders fulfilled by the first market venue and the second market venue over a prior period of time;
determine a set of real-time order statistics for a plurality of executed orders fulfilled by the first market venue and the second market venue over a recent period of time; and
apply the historical data and the real-time order statistics to determine an expected behavior of the first market venue and the second market venue,
wherein the desired make live time is based at least in part upon the expected behavior.

14. The system according to claim 10, wherein the instructions further include instructions to cause the processing circuitry to:
access historical data for executed orders fulfilled by the first market venue and the second market venue over a prior period of time;
determine a set of real-time order statistics for a plurality of executed orders fulfilled by the first market venue and the second market venue over a recent period of time; and
apply the historical data and the real-time order statistics to determine an expected behavior of the first market venue and the second market venue,
wherein the make live time is based at least in part upon the expected behavior.

15. A method, comprising:
receiving at a first market venue at a receipt time, from a first order system of a plurality of order systems, an order comprising a product identifier, at least one order characteristic, a make live time, and pricing information;
determining a difference between the receipt time and the make live time; and
queuing the order in a queue of a plurality of orders based on the determination.

16. The method according to claim 15, further comprising:
querying a first market clock at the first market venue to obtain a first market time;
querying a second market clock at a second market venue to obtain a second market time; and
calculating a time, using the first market time and the second market time, at which to queue the order at the first market venue and a second time to queue the order at the second market venue so that the order appears for execution approximately simultaneously at the first market venue and the second market venue.

17. The method according to claim 16, further comprising synchronizing the first market clock with the second market clock.
